(19) United States
(12) Patent Application Publication
(10) Pub. No.: US 2016/0086508 A1
(43) Pub. Date: Mar. 24, 2016

(54) SYSTEM AND METHOD FOR FACILITATING THE LEARNING OF LANGUAGE

(71) Applicant: Learning Circle Kids LLC, Camas, WA (US)

(72) Inventors: Ann H. McCormick, Leavenworth, WA (US); Sherrilyn Fisher, Camas, WA (US)

(21) Appl. No.: 14/862,097

(22) Filed: Sep. 22, 2015

Related U.S. Application Data
(60) Provisional application No. 62/053,766, filed on Sep. 22, 2014.

(51) Int. Cl. G09B 17/00; G06F 3/0488; G06F 3/0484; G09B 5/02

(52) U.S. Cl. CPC G09B 17/003; G09B 5/02; G06F 3/04886; G06F 3/04842

(57) ABSTRACT

It can be difficult for a language learner to learn how to type. One technique for learning a language uses pictogram alongside spelled words. A system and method are presented in which a user can type while toggling between spelled words and pictograms. A table of a number of words and their corresponding pictograms are programmed into a typing system. When a user types a word found in the table, the words appears highlighted. The user can switch between the spelled word and the pictogram by selecting the word or pictogram within a single display area. Alternative embodiments include a keyboard for typing and a scrollbar where a user can select pictograms.

### CROSS-REFERENCE TO RELATED APPLICATIONS

This application claims the benefit of U.S. Provisional Application No. 62/053,766 filed Sep. 22, 2014, hereby incorporated by reference in its entirety.

### BACKGROUND OF THE INVENTION

1. Field of the Invention

The present invention relates generally to software and text entry systems, and specifically to touchscreen keyboards for use with computing devices that facilitate the learning of language.

2. Discussion of the Background

It is well-known that the learning of a new language, specifically how to spell, is facilitated by providing learners with pictorial images of the words to be spelled Thus, for example, books for teaching children to read, or for teaching adults to read a new language, often include pictures alongside words being taught.

When making the transition to typing, the learner can no longer easily rely on pictorial representation of the words. The learner is, at this stage, relying on their knowledge or of pronunciation rules in typing.

There is a need in the art for a method and system that allows learners to type while making use of pictorial images of the words they are typing. Both the method and system should be compatible with existing hardware and be easy to use.

### BRIEF SUMMARY OF THE INVENTION

The present invention overcomes the limitations of prior art language learning methods and systems by providing a typing system that can present both typed words and pictorial representation (pictograms) of words being typed.

It is one aspect to provide a computer-implemented method for displaying input. The method includes: storing a look-up table in a memory of an electronic device, where the electronic device further includes a processor and a touch screen programmed to present an input area and a display area, where the look-up table includes a plurality of words each having a corresponding pictogram; presenting a keyboard in the input area of the touch screen, where the keyboard includes inputs for individual letters of the alphabet; accepting user input from the keyboard, where the input includes letters of the alphabet; presenting the accepted user input in the display area; and determining if the user input includes a word found in the look-up table, and if so, presenting the pictogram corresponding to the determined word in the display area.

It is another aspect to provide a computing device having a memory, a processor, and a touch display, where the computing device is programmed to present to a user, on the touch display, an input area and a display area. The computing device is programmed to: store a look-up table in the memory of the electronic device, where the look-up table includes a plurality of words each having a corresponding pictogram; present a keyboard in the input area of the touch screen, where the keyboard includes inputs for individual letters of the alphabet; accept user input from the keyboard, where the input includes letters of the alphabet; present the accepted user input in the display area; and determine if the user input from the keyboard includes a word found in the look-up table, and if so, present the pictogram corresponding to the determined word in the display area.

It is yet another aspect to provide a computer-implemented method for displaying input. The method includes: storing a look-up table in a memory of an electronic device, where the electronic device further includes a processor and a touch screen programmed to present a first input area, a second input area, and a display area, where the look-up table includes a plurality of words each having a corresponding pictogram; presenting a keyboard in the first input area of the touch screen, where the keyboard includes inputs for individual letters of the alphabet; accepting user input from the keyboard, where the input includes letters of the alphabet; presenting the accepted user input in the display area; presenting a one or more pictograms of the look-up table in the second input area; accepting user input of a pictogram from the second input area; and presenting the accepted pictogram in the display area. The method is such that the user can provide input to the display area from two input areas.

It is one aspect to provide a computing device having a memory, a processor, and a touch display, where the computing device is programmed to present to a user, on the touch display, a first input area, a second input area, and a display area. The computing device is programmed to: store a look-up table in a memory of an electronic device, where the look-up table includes a plurality of words each having a corresponding pictogram; present a keyboard in the first input area of the touch screen, where the keyboard includes inputs for individual letters of the alphabet; accept user input from the keyboard, where the input includes letters of the alphabet; present the accepted user input in the display area; present a one or more pictograms of the look-up table in the second input area; accept user input of a pictogram from the second input area; and present the accepted pictogram in the display area. The computing device is such that the user can provide input to the display area from two input areas.

### BRIEF DESCRIPTION OF THE SEVERAL VIEWS OF THE DRAWING

FIG. 1 is a block diagram illustrating a portable electronic device, according to some embodiments of the invention;

FIG. 2 illustrates one embodiment of the present invention as implemented as an application on a computing device;

FIG. 3 is one example of a look-up table of corresponding pairs of text (letters or words) and pictograms;

FIG. 4 is an example of display which includes text; and

FIG. 5 illustrates a display which includes both text and pictograms.

Reference symbols are used in the Figures to indicate certain components, aspects or features shown therein, with reference symbols common to more than one Figure indicating like components, aspects or features shown therein.

### DETAILED DESCRIPTION OF THE INVENTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

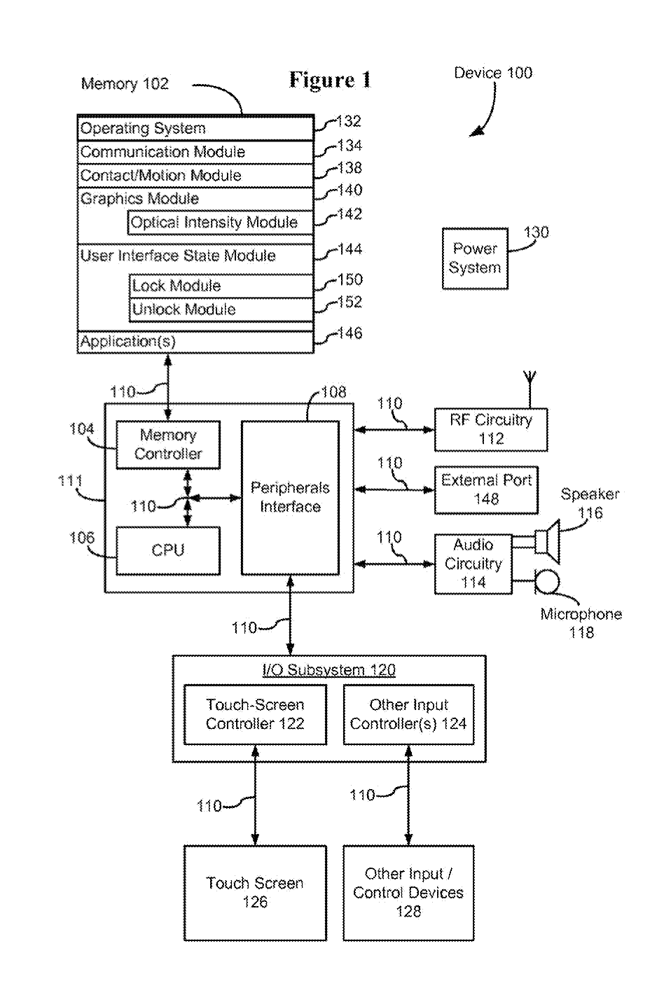

FIG. 1 illustrates a portable electronic device, according to some embodiments of the invention. The device 100 includes a memory 102, a memory controller 104, one or more processing units (CPUs) 106, a peripherals interface 108, RF circuitry 112, audio circuitry 114, a speaker 116, a microphone 118, an input/output (I/O) subsystem 120, a touch screen 126, other input or control devices 128, and an external port 148. These components communicate over the one or more communication buses or signal lines 110. The device 100 can be any portable electronic device, including but not limited to a handheld computer, a tablet computer, a mobile phone, a media player, a personal digital assistant (PDA), or the like, including a combination of two or more of these items. It should be appreciated that the device 100 is only one example of a portable electronic device 100, and that the device 100 may have more or fewer components than shown, or a different configuration of components. The various components shown in FIG. 1 may be implemented in hardware, software or a combination of hardware and software, including one or more signal processing and/or application specific integrated circuits.

The memory 102 may include high-speed random access memory and may also include non-volatile memory, such as one or more magnetic disk storage devices, flash memory devices, or other non-volatile solid state memory devices. In some embodiments, the memory 102 may further include storage remotely located from the one or more processors 106, for instance network attached storage accessed via the RF circuitry 112 or external port 148 and a communications network (not shown) such as the Internet, intranet(s), Local Area Networks (LANs), Wide Local Area Networks (WLANs), Storage Area Networks (SANs) and the like, or any suitable combination thereof. Access to the memory 102 by other components of the device 100, such as the CPU 106 and the peripherals interface 108, may be controlled by the memory controller 104.

The peripherals interface 108 couples the input and output peripherals of the device to the CPU 106 and the memory 102. The one or more processors 106 run various software programs and/or sets of instructions stored in the memory 102 to perform various functions for the device 100 and to process data.

In some embodiments, the peripherals interface 108, the CPU 106, and the memory controller 104 may be implemented on a single chip, such as a chip 111. In some other embodiments, they may be implemented on separate chips.

The RF (radio frequency) circuitry 112 receives and sends electromagnetic waves. The RF circuitry 112 converts electrical signals to/from electromagnetic waves and communicates with communications networks and other communications devices via the electromagnetic waves. The RF circuitry 112 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 112 may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 114, the speaker 116, and the microphone 118 provide an audio interface between a user and the device 100. The audio circuitry 114 receives audio data from the peripherals interface 108, converts the audio data to an electrical signal, and transmits the electrical signal to the speaker 116. The speaker converts the electrical signal to human-audible sound waves. The audio circuitry 114 also receives electrical signals converted by the microphone 116 from sound waves. The audio circuitry 114 converts the electrical signal to audio data and transmits the audio data to the peripherals interface 108 for processing. Audio data may be may be retrieved from and/or transmitted to the memory 102 and/or the RF circuitry 112 by the peripherals interface 108. In some embodiments, the audio circuitry 114 also includes a headset jack (not shown). The headset jack provides an interface between the audio circuitry 114 and removable audio input/output peripherals, such as output-only headphones or a headset with both output (headphone for one or both ears) and input (microphone).

The I/O subsystem 120 provides the interface between input/output peripherals on the device 100, such as the touch screen 126 and other input/control devices 128, and the peripherals interface 108. The I/O subsystem 120 includes a touch-screen controller 122 and one or more input controllers 124 for other input or control devices. The one or more input controllers 124 receive/send electrical signals from/to other input or control devices 128. The other input/control devices 128 may include physical buttons (e.g., push buttons, rocker buttons, etc.), dials, slider switches, sticks, and so forth.

The touch screen 126 provides both an output interface and an input interface between the device and a user. The touch-screen controller 122 receives/sends electrical signals from/to the touch screen 126. The touch screen 126 displays visual output to the user. The visual output may include text, graphics, video, and any combination thereof. Some or all of the visual output may correspond to user-interface objects, further details of which are described below.

The touch screen 126 also accepts input from the user based on haptic and/or tactile contact. The touch screen 126 forms a touch-sensitive surface that accepts user input. The touch screen 126 and the touch screen controller 122 (along with any associated modules and/or sets of instructions in the memory 102) detects contact (and any movement or break of the contact) on the touch screen 126 and converts the detected contact into interaction with user-interface objects, such as one or more soft keys, that are displayed on the touch screen. In an exemplary embodiment, a point of contact between the touch screen 126 and the user corresponds to one or more digits of the user. The touch screen 126 may use LCD (liquid crystal display) technology, or LPD (light emitting polymer display) technology, although other display technologies may be used in other embodiments. The touch screen 126 and touch screen controller 122 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 126. The touch-sensitive display may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference. However, the touch screen 126 displays visual output from the portable device, whereas touch sensitive tablets do not provide visual output. The user may make contact with the touch screen 126 using any suitable object or appendage, such as a stylus, finger, and so forth.

The device 100 also includes a power system 130 for powering the various components. The power system 130 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system 132, a communication module (or set of instructions) 134, a contact/motion module (or set of instructions) 138, a graphics module (or set of instructions) 140, a user interface state module (or set of instructions) 144, and one or more applications (or set of instructions) 146.

The operating system 132 (e.g., LINUX, UNIX, iOS, WINDOWS, or an embedded operating system) includes various software components and/or drivers for controlling and managing general system tasks (e.g., memory management, storage device control, power management, etc.) and facilitates communication between various hardware and software components.

The communication module 134 facilitates communication with other devices over one or more external ports 148 and also includes various software components for handling data received by the RF circuitry 112 and/or the external port 148. The external port 148 (e.g., Universal Serial Bus (USB), FIREWIRE, etc.) is adapted for coupling directly to other devices or indirectly over a network (e.g., the Internet, wireless LAN, etc.).

The contact/motion module 138 detects contact with the touch screen 126, in conjunction with the touch-screen controller 122. The contact/motion module 138 includes various software components for performing various operations related to detection of contact with the touch screen 122, such as determining if contact has occurred, determining if there is movement of the contact and tracking the movement across the touch screen, and determining if the contact has been broken (i.e., if the contact has ceased). Determining movement of the point of contact may include determining speed (magnitude), velocity (magnitude and direction), and/or an acceleration (including magnitude and/or direction) of the point of contact. In some embodiments, a contact/motion module and the touch screen controller 122 also detects contact on the touchpad.

The graphics module 140 includes various known software components for rendering and displaying graphics on the touch screen 126. Note that the term “graphics” includes any object that can be displayed to a user, including without limitation text, web pages, icons (such as user-interface objects including soft keys), digital images, videos, animations and the like.

In some embodiments, the graphics module 140 includes an optical intensity module 142. The optical intensity module 142 controls the optical intensity of graphical objects, such as user-interface objects, displayed on the touch screen 126. Controlling the optical intensity may include increasing or decreasing the optical intensity of a graphical object. In some embodiments, the increase or decrease may follow predefined functions.

The user interface state module 144 controls the user interface state of the device 100. The user interface state module 144 may include a lock module 150 and an unlock module 152. The lock module detects satisfaction of any of one or more conditions to transition the device 100 to a user-interface lock state and to transition the device 100 to the lock state. The unlock module detects satisfaction of any of one or more conditions to transition the device to a user-interface unlock state and to transition the device 100 to the unlock state. Further details regarding the user interface states are described below.

The one or more applications 146 can include any applications installed on the device 100, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc.

In some embodiments, the device 100 may include the functionality of an MP3 player, such as an iPod (trademark of Apple Computer, Inc.). The device 100 may, therefore, include a connector that is compatible with the iPod. In some embodiments, the device 100 may include one or more optional optical sensors (not shown), such as CMOS or CCD image sensors, for use in imaging applications.

In some embodiments, the device 100 is a device where operation of a predefined set of functions on the device is performed exclusively through the touch screen 126 and, if included on the device 100, the touchpad. By using the touch screen and touchpad as the primary input/control device for operation of the device 100, the number of physical input/control devices (such as push buttons, dials, and the like) on the device 100 may be reduced. In one embodiment, the device 100 includes the touch screen 126, the touchpad, a push button for powering the device on/off and locking the device, a volume adjustment rocker button and a slider switch for toggling ringer profiles. The push button may be used to turn the power on/off on the device by depressing the button and holding the button in the depressed state for a predefined time interval, or may be used to lock the device by depressing the button and releasing the button before the predefined time interval has elapsed. In an alternative embodiment, the device 100 also may accept verbal input for activation or deactivation of some functions through the microphone 118.

The predefined set of functions that are performed exclusively through the touch screen and the touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

The following description includes details of functional aspects of applications 146 which allow device 100 to operate as a keyboard. It should also be appreciated that while device 100 has been described as a portable device, there is no inherent limitation that device 100 need be portable and, for example, non-portable devices such as desktop computers maybe include applications that provide the same functionality as is described herein.

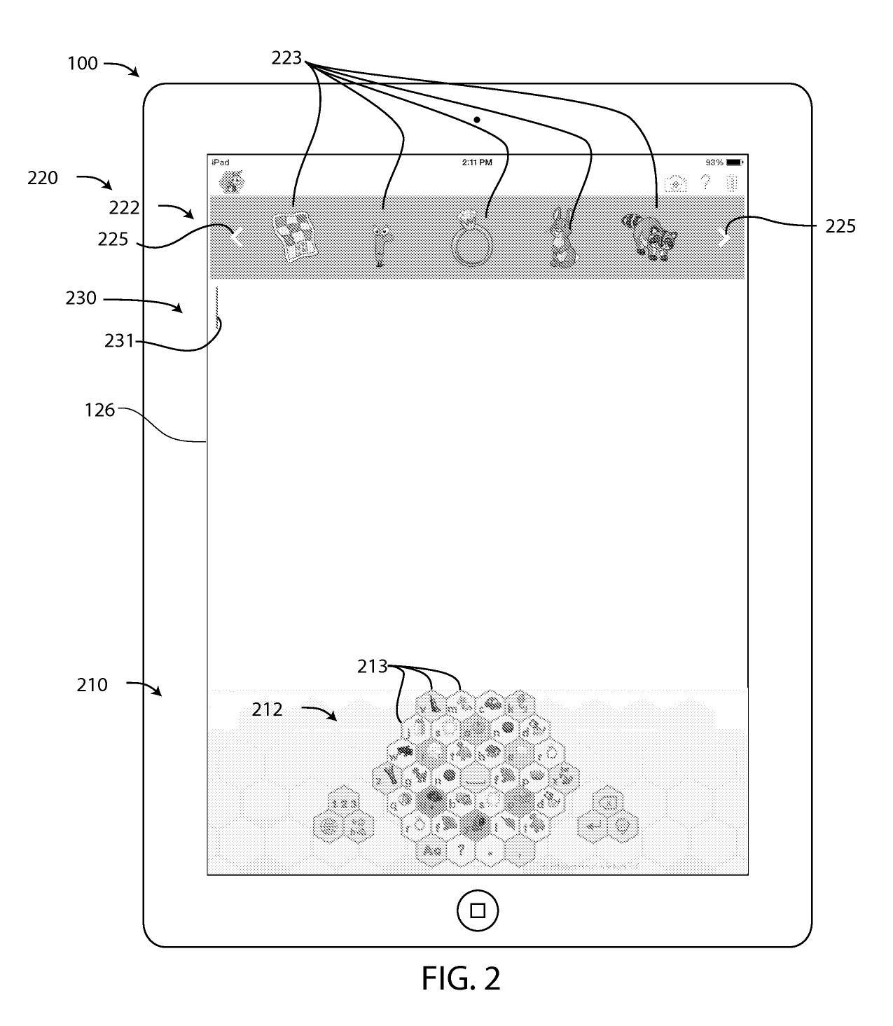

Embodiments executed, for example and without limitation, on device 100 are shown in FIG. 2, which illustrates one embodiment of the present invention as implemented as an application 146. Computing device 100 of FIG. 2 is programmed similar the programming of a keyboard, in that certain areas of touch screen 126, when touched by a user, are interpreted by application 146 as corresponding to the user selecting certain letters of the alphabet, and be presented on other areas of the touch screen and may be stored in memory 102. FIG. 2 illustrates computing device 110 including two input areas—a first input area 210 and a second input area 220—and a display area 230.

First input area 210 includes a keyboard 212 having a plurality of keys 213 each corresponding to a letter, number, or punctuation mark. The illustrated keyboard 212 is, for example and without limitation, a keyboard having hexagonal keys 213 described in co-pending and co-owned U.S. Provisional Application No. 61/771,558 filed Mar. 1, 2013, entitled “TOUCH ACTIVATED KEYBOARD FOR LEARNING A LANGUAGE AND ENTERING TEXT”, and the U.S. patent application Ser. No. 14/067,426, filed Oct. 30, 2013, which are incorporated herein by reference. Keyboard 212 may include all of the letters of the alphabet, or may include only some of the letters of the alphabet. Keyboard 212 is specifically designed to facilitate the learning of a language (by a child, for example) by arranging the keys in a manner such that the letters of many simple words are adjacent. Thus, for example, the words “and,” “her,” and “the” to be typed by touching adjacent keys. Alternatively, keyboard 212 may be a more conventional keyboard, having square keys laid out in 3 or 4 rows, as in a QWERTY or Divorak keyboard.

Second input area 220 includes a scrollbar 222 that includes a plurality of pictograms 223, each representative of a letter or word, and arrows 225 to scroll through the pictograms, including other pictures which are not visible until the scrollbar is scrolled.

Application 146, and optionally other programming in memory 102, peripherals interface 108 and/or touch-screen controller 122, respond to the touch of a user at the appropriate location on touch screen 126 and interpret the touch as the corresponding letter, number, or punctuation marks input from key 213 of keyboard 210 and pictogram 223 from scrollbar 220, and presents the input in display area 230, at cursor 231 location. As a user provides input from input areas 210 and/or 220, cursor 231 moves to the right as the input proceeds.

Application 146 allows a user to provide input from first input area 210 and second input area 220, which is presented at cursor 231 of display area 230. Thus, when a user selects a key 213 of first input area 210, the letter, punctuation mark, number, or space is presented by application 146 at cursor 231 of display area 230. Likewise, when a user selects a pictogram 223 from second input area 220, the pictogram is presented by application 146 at cursor 231 of display area 230. Display area 230 may thus contain a combination of typed characters and typed pictograms.

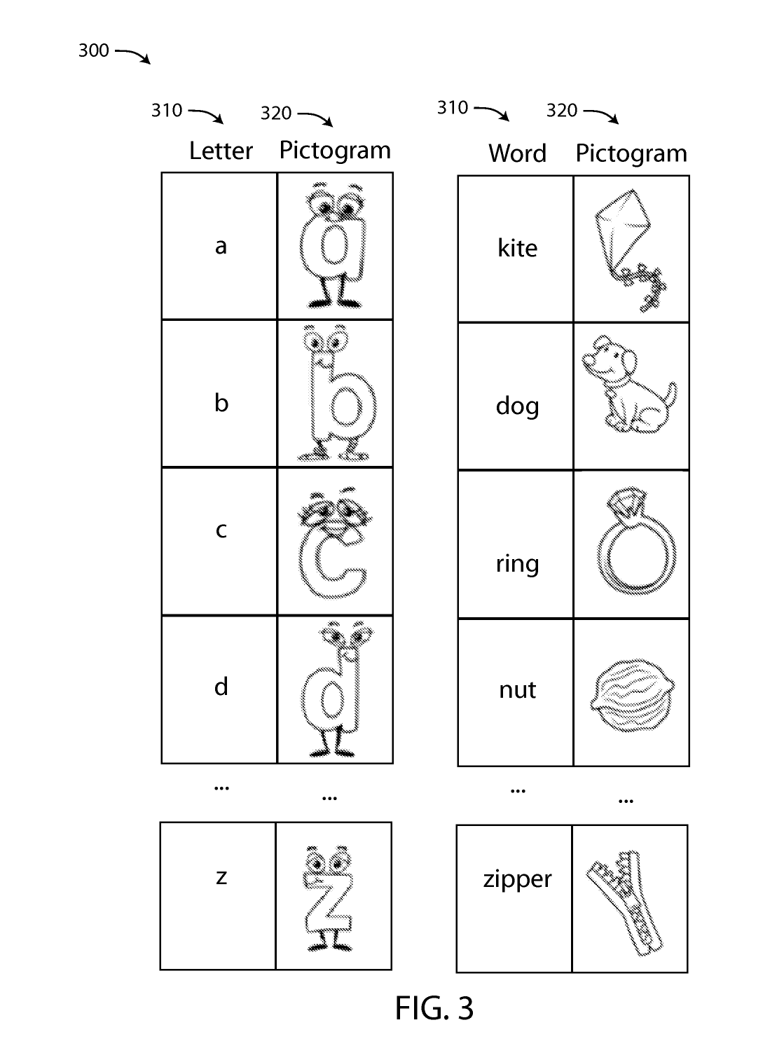

In one embodiment, each pictogram 223 has a corresponding letter or word. FIG. 3 is one example of corresponding pairs of text (letters or words) 310 and pictograms 320. In another embodiment, a digital representation of text 310 and pictograms 320 are stored in memory 102 as a look-up table 300. In one embodiment, the text is stored in ASCII format, and the pictograms are stored as image files (e.g., JPEG, TIFF, GIF, or BMP). Look-up table 300 may include a large number of pictogram and, in certain embodiments, includes pictograms representing words starting with each letter of the alphabet.

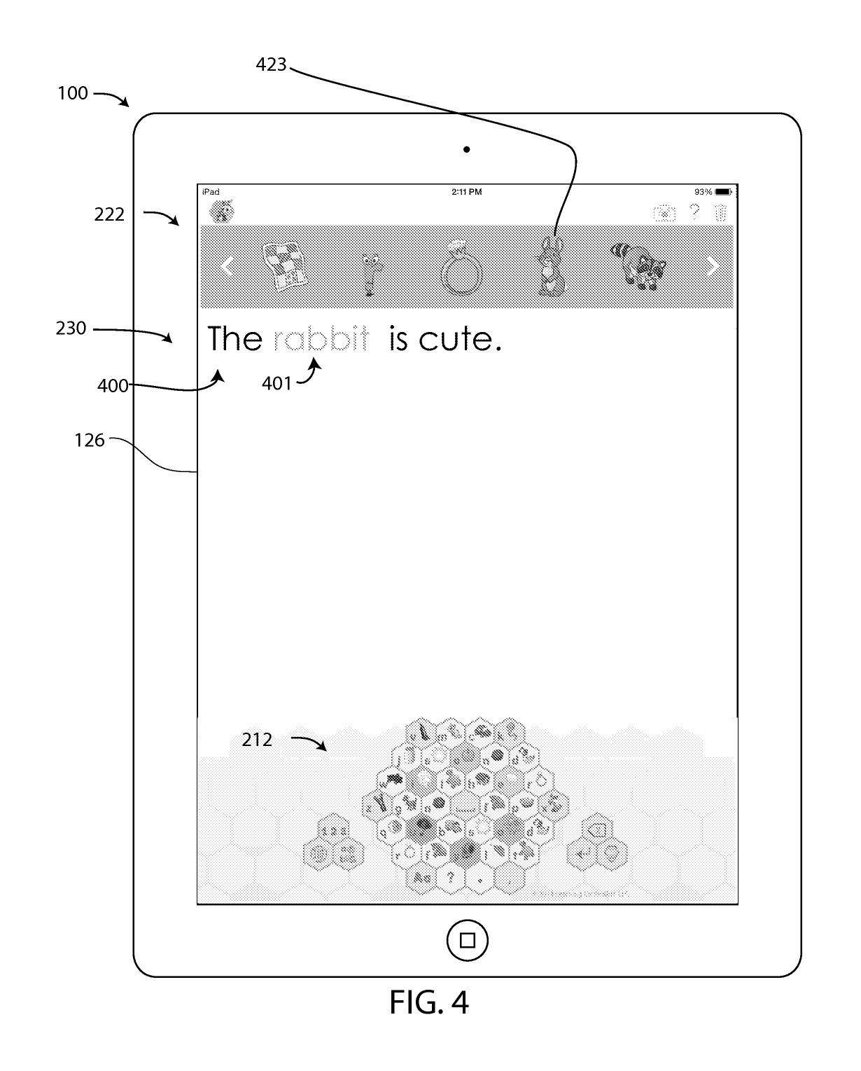

FIG. 4 is an example of touch screen 126 which includes text 400 that reads: “The rabbit is cute.” In general, text 400 may include no words found in lookup-table 300, or may include one or more words found the look-up table. In one embodiment, application 146 scans the text of display area 230 or, alternatively the input from keyboard 212, for letters and/or words which are stored in look-up table 300 to identify text input having corresponding pictograms. Application 146 may, additionally, highlight text that is identified as being in look-up table 300. Thus, for example and without limitation, the color of text in display area 230 may be modified to indicate to the user that a word on display area 230 has a corresponding pictogram. In FIG. 4, of all the words in display area 230, only the word “rabbit” is present in look-up table 300, and has a pictogram 423 of a rabbit. The words “The,” “is,” “cute,” and punctuation mark “.” are in one color (black, for example), while the word “rabbit” is in a second color (red, for example). Alternatively, the highlighting may include the user of different fonts, formatting, or background colors for the highlighted word.

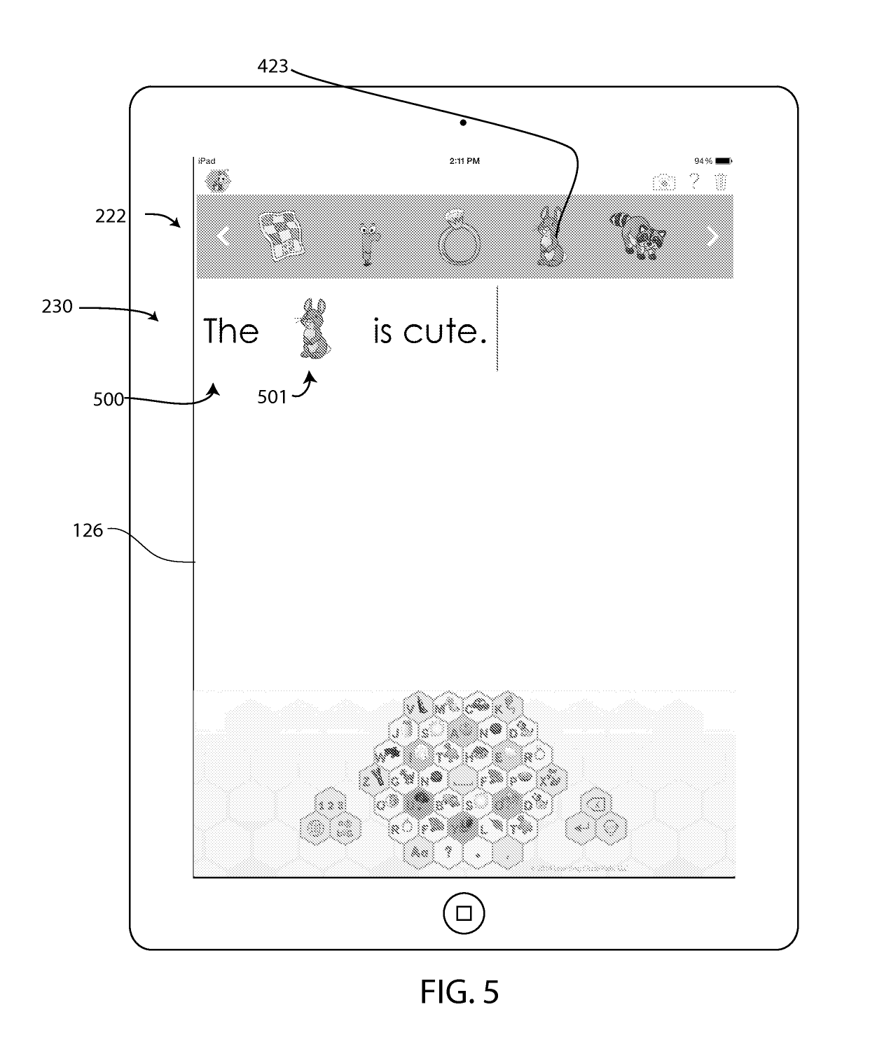

FIG. 5 illustrates a display that includes both text and pictograms, and illustrates, for example and without limitation, how application 146 responds to a user selecting the highlighted word 401 “rabbit” from the display of FIG. 4. When a highlighted word is thus selected, application 146 determines the corresponding pictogram from look-up table 300, and replaces the word with the corresponding pictogram. Thus, as illustrated in FIG. 5, the word “rabbit” from FIG. 4 has been replaced with pictogram 401 (also shown as pictogram 423 in second input area 220), and which corresponds to the word “rabbit.”

In one embodiment, application 146 permits display 230 to toggle back and forth between text and pictograms. Thus, for example, from display area 230 of FIG. 5, a user may select pictogram 501, and application 146 causes display area 230 to change to that of FIG. 4, where the pictogram is replaced with the corresponding word.

In another embodiment, touch screen 126 includes only one input area—input area 210, and pictograms appear in display by selected highlighted words or letters.

In an alternative embodiment, application 146 compares words input in keyboard 212 against words in look-up table 300, and presents those words as the corresponding pictogram instead of the typed word. Thus, for example, application 146 may compare each word as it is input from keyboard 212 with words in look-up table 300 and either present the letter or words to appear in display area 230 or, if an input word is present in the look-up table, will present the pictogram corresponding to the typed word to appear in the display area instead of the word.

As one example, if a user types “The rabbit is cute.” in keyboard 212, the word “The” will first appear. As the user types the last letter of “rabbit,” application 146 finds the word in look-up table 300 and presents the pictogram of the rabbit after the word “The.” The words “is” and “cute” do not appear in look-up table 300 and will thus appear as text in display area 230. Display 230 will thus appear as the display of FIG. 5, which includes both text and pictograms. The user may select the pictogram of the rabbit, which will change the pictogram to a typed word “rabbit,” as in FIG. 4, and may then select the word “rabbit” and the display will change back to the display of FIG. 5, with a pictogram of the rabbit.

One embodiment of each of the methods described herein is in the form of a computer program that executes on a processing system, e.g., a one or more processors that are part of a computing system. Thus, as will be appreciated by those skilled in the art, embodiments of the present invention may be embodied as a method, an apparatus such as a special purpose apparatus, an apparatus such as a data processing system, or a carrier medium, e.g., a computer program product containing non-transitory computer readable medium. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system. It should further be appreciated that although the coding of inventive language learning system has not be discussed in detail, the invention is not limited to a specific coding method.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A computer-implemented method for displaying input, comprising:
storing a look-up table in a memory of an electronic device, where said electronic device further includes a processor and a touch screen programmed to present an input area and a display area, where said look-up table includes a plurality of words each having a corresponding pictogram;
presenting a keyboard in said input area of said touch screen, where said keyboard includes inputs for individual letters of the alphabet;
accepting user input from said keyboard, where said input includes letters of the alphabet;
presenting the accepted user input in said display area; and
determining if the user input includes a word found in said look-up table, and if so, presenting the pictogram corresponding to the determined word in said display area.

2. The computer-implemented method for displaying input of claim 1, further comprising:
accepting the user selection of the pictogram from the display area;
determining the word corresponding to the selected pictogram from said look-up table; and
replacing the selected pictogram in said display area with the word corresponding to said selected pictogram.

3. The computer-implemented method for displaying input of claim 2, further comprising:
highlighting the word corresponding to said selected pictogram,
such that the user is provided with an indication that said highlighted word has a corresponding pictogram.

4. The computer-implemented method for displaying input of claim 3, wherein said highlighting the word corresponding to said selected pictogram includes presenting the word corresponding to said selected pictogram in a font, color, or with a background different from words not in said look-up table.

5. The computer-implemented method for displaying input of claim 3, further comprising:
accepting the user selection of the highlighted word from the display area;
determining the pictogram corresponding to said selected highlighted word from said look-up table; and
replacing the selected highlighted word in said display area with the pictogram corresponding to said selected highlighted word.

6. The computer-implemented method for displaying input of claim 1, wherein said input area is a first input area, and where said method further comprises:
presenting a second input area, where said second input area includes one or more pictograms of the look-up table;
accepting user input of a pictogram from the second input area; and
presenting the accepted pictogram in said display area.

7. The computer-implemented method for displaying input of claim 6, further comprising:
accepting a user selected a pictogram from the display area,
determining the word corresponding to said pictogram from said look-up table; and
replacing the selected pictogram in said display area with the word corresponding to said selected pictogram.

8. A computing device having a memory, a processor, and a touch display, where said computing device is programmed to present to a user, on the touch display, an input area and a display area, wherein the computing device is programmed to:
store a look-up table in the memory of the electronic device, where said look-up table includes a plurality of words each having a corresponding pictogram;
present a keyboard in the input area of said touch screen, where the keyboard includes inputs for individual letters of the alphabet;
accept user input from the keyboard, where the input includes letters of the alphabet;
present the accepted user input in said display area; and
determine if the user input from the keyboard includes a word found in said look-up table, and if so, present the pictogram corresponding to the determined word in said display area.

9. The computing device of claim 8, wherein the computing device is further programmed to:
accept the user selection of the pictogram from the display area;
determine the word corresponding to the selected pictogram from said look-up table; and
replace the selected pictogram in said display area with the word corresponding to said selected pictogram.

10. The computing device of claim 9, wherein the computing device is further programmed to:
highlight the word corresponding to said selected pictogram,
such that the user is provided with an indication that said highlighted word has a corresponding pictogram.

11. The computing device of claim 10, wherein the computing device is further programmed to highlight the word corresponding to said selected pictogram by presenting the word corresponding to said selected pictogram in a font, color, or with a background different from words not in said look-up table.

12. The computing device of claim 10, wherein the computing device is further programmed to:
accept the user selection of the highlighted word from the display area;
determine the pictogram corresponding to said selected highlighted word from said look-up table; and
replace the selected highlighted word in said display area with the pictogram corresponding to said selected highlighted word.

13. The computing device of claim 8, wherein said input area is a first input area, and wherein the computing device is further programmed to:
present a second input area, where said second input area includes one or more pictograms of the look-up table;
accept user input of a pictogram from the second input area; and
present the accepted pictogram in said display area.

14. The computing device of claim 13, wherein the computing device is further programmed to:
accept a user selected a pictogram from the display area,
determine the word corresponding to said pictogram from said look-up table; and
replace the selected pictogram in said display area with the word corresponding to said selected pictogram.

15. A computer-implemented method for displaying input, comprising:
storing a look-up table in a memory of an electronic device, where said electronic device further includes a processor and a touch screen programmed to present a first input area, a second input area, and a display area, where said look-up table includes a plurality of words each having a corresponding pictogram;
presenting a keyboard in said first input area of said touch screen, where said keyboard includes inputs for individual letters of the alphabet;
accepting user input from said keyboard, where said input includes letters of the alphabet;
presenting the accepted user input in said display area;
presenting a one or more pictograms of the look-up table in the second input area;
accepting user input of a pictogram from the second input area; and
presenting the accepted pictogram in said display area,
such that the user can provide input to the display area from two input areas.

16. The computer-implemented method for displaying input of claim 15, further comprising:
determining if user input from said keyboard includes a word found in said look-up table, and if so, presenting the pictogram corresponding to the determined word in said display area.

17. The computer-implemented method for displaying input of claim 16, further comprising:
accepting the user selection of a pictogram from the display area;
determining the word corresponding to the selected pictogram from said look-up table; and
replacing the selected pictogram in said display area with the word corresponding to said selected pictogram.

18. The computer-implemented method for displaying input of claim 17, further comprising:
highlighting a word in the display area found in the look-up table,
such that the user is provided with an indication that said highlighted word has a corresponding pictogram.

19. The computer-implemented method for displaying input of claim 18, wherein said highlighting the word in the display area found in the look-up table includes presenting the word in the display area found in the look-up table in a font, color, or with a background different from words not in said look-up table.

20. The computer-implemented method for displaying input of claim 18, further comprising:
accepting the user selection of the highlighted word from the display area;
determining the pictogram corresponding to said selected highlighted word from said look-up table; and
replacing the selected highlighted word in said display area with the pictogram corresponding to said selected highlighted word.

21. A computing device having a memory, a processor, and a touch display, where said computing device is programmed to present to a user, on the touch display, a first input area, a second input area, and a display area, wherein the computing device is programmed to:
store a look-up table in a memory of an electronic device, where said look-up table includes a plurality of words each having a corresponding pictogram;
present a keyboard in said first input area of said touch screen, where said keyboard includes inputs for individual letters of the alphabet;
accept user input from said keyboard, where said input includes letters of the alphabet;
present the accepted user input in said display area;
present a one or more pictograms of the look-up table in the second input area;
accept user input of a pictogram from the second input area; and
present the accepted pictogram in said display area,
such that the user can provide input to the display area from two input areas.

22. The computing device of claim 21, wherein the computing device is further programmed to:
determine if user input from said keyboard includes a word found in said look-up table, and if so, present the pictogram corresponding to the determined word in said display area.

23. The computing device of claim 22, wherein the computing device is further programmed to:
accept the user selection of a pictogram from the display area;
determine the word corresponding to the selected pictogram from said look-up table; and
replace the selected pictogram in said display area with the word corresponding to said selected pictogram.

24. The computing device of claim 21, wherein the computing device is further programmed to:
highlight a word in the display area found in the look-up table,
such that the user is provided with an indication that said highlighted word has a corresponding pictogram.

25. The computing device of claim 24, wherein the computing device is further programmed to:
highlight the word in the display area found in the look-up table by presenting the word in the display area found in the look-up table in a font, color, or with a background different from words not in said look-up table.

26. The computing device of claim 24, wherein the computing device is further programmed to:
accept the user selection of the highlighted word from the display area;
determine the pictogram corresponding to said selected highlighted word from said look-up table; and
replace the selected highlighted word in said display area with the pictogram corresponding to said selected highlighted word.
